(19) United States
(12) Patent Application Publication
(10) Pub. No.: US 2005/0025105 A1
(43) Pub. Date: Feb. 3, 2005

(54) Apparatus and method for processing packets in wireless local area network access point

(76) Inventor: Seon-Soo Rue, Suwon-si (KR)

Correspondence Address: Robert E. Bushnell, Suite 300, 1522 K Street, N.W., Washington, DC, 20005, US

(21) Appl. No.: 10/879,200

(22) Filed: Jun. 30, 2004

(30) Foreign Application Priority Data
Jul. 30, 2003 (KR) 2003-52881

(51) Int. Cl. H04Q 7/24

(52) U.S. Cl. 370/338; 370/412

(57) ABSTRACT

An apparatus and method for processing packets in a Wireless Local Area Network (WLAN) access point includes a WLAN access point cooperated with the WLAN parses the received packets, determines whether the received packets are voice packets which must be preferentially processed or signaling packets of a protocol related to a call control in order to guarantee a quality of VoIP service, gives a priority to the corresponding packets in a differentiated manner according to the determined result, and preferentially processes the packets given a high priority. Thus, it is possible to guarantee the quality of VoIP service.

### CLAIM OF PRIORITY

This application makes reference to, incorporates the same herein, and claims all benefits accruing under 35 U.S.C. § 119 from an application for METHOD AND APPARATUS FOR PACKET PROCESSING IN WLAN ACCESS POINT filed in the Korean earlier filed in the Korean Intellectual Property Office on 30 Jul. 2003 and there duly assigned Serial No. 2003-52881.

### BACKGROUND OF THE INVENTION

1. Field of the Invention

The present invention generally relates to an apparatus and method for processing packets on a Wireless Local Area Network (WLAN) and, more particularly, to an apparatus and method for processing packets in a WLAN access point, in which the WLAN access point, which is designed to provide a Voice over Internet Protocol (VoIP) service based on WLAN technology such as IEEE (Institute of Electrical and Electronics Engineers) 802.11 and IEEE 802.11b, processes the packets transmitted/received through Ethernet or WLAN in a differentiated manner in order to guarantee Quality of Service (QoS), thereby enhancing QoS still more.

2. Description of the Related Art

With advancement in industrial societies, a quantity of information is extremely increased day by day. Hence, a demand of users who intend to use massive information in a rapid and accurate manner is also rapidly increased.

In order to rapidly and accurately transceive these massive information, there is a need for high-speed data transmission technology. Further, according to a recent tendency, thanks to development of circuit and component technologies, capability to use frequency bands without permission, popularization of portable computers and so forth, a growing interest is taken in the WLAN capable of guaranteeing a certain extent of mobility and transmitting data at a high speed, and thus products for the WLAN are developed and distributed by their manufacturers.

In the initial stage of development of the WLAN, there was no standard architecture. However, recently, there has been in the process of preparing standardization based on the architecture recommended by IEEE 802.11 Committee, as one of standardization tasks of the WLAN.

In addition, with development of Internet, integrated telephone processing can be realized by application of an existing Internet Protocol (IP) network as it stands. Thereby, a wide use has been made of a VoIP service, which is adapted to allow telephone users to make a long-distance call as well as an international call under the environment of Ethernet only at the price of a local call.

Therefore, IP networks have been converted into a structure to guarantee a quality of VoIP service. Conventionally, the IP networks have been established with the aim of efficient transmission of text-oriented data, and require QoS only within a range of preventing data from being damaged or lost. However, because of advancement in IP network technologies, it is possible to transmit voice data on the IP network in a real time. For this reason, technologies to guarantee the quality of VoIP service are increasingly playing an important role.

Thus, the WLAN system using the IP network has a tendency that the importance of QoS is gradually increased so as to process general data as well as voice data, and simultaneously to process voice data, i.e., VoIP signaling data at a high quality.

However, in the present VoIP service network, any VoIP terminal sets a Type of Service (ToS) flags on IP packets to transmit the packets to the Ethernet. In a router mode, the WLAN access point preferentially processes the packets whose ToS flags are not set. However, in a bridge mode, the WLAN access point transmits VoIP packets in the received sequence to any targeted Voice over WLAN (VoWLAN) terminal.

In this case, the WLAN access point retransmits the received packets in the received order without differentiation of data packets and VoIP packets to wireless terminals through the WLAN.

According to this earlier art, when both data packet and VoIP packet are simultaneously received, they are given the same priority. Due to this processing, when many of data packets are received between the VoIP packets, the VoIP packets are not uniformly stored in jitter buffers defined by VoIP. As a result, a transmission delay of the VoIP packet is seriously generated, so that it is impossible to guarantee QoS.

Further, even when VoIP packet received according to the earlier art is given a priority, this is only applied to Real Time Protocol (RTP) packets on User Data Protocol packets of the IP packets. Thus, a signaling packet exchange for providing terminal mobility between WLAN access points installed on multiple subnets of the WLAN becomes delayed, so that terminals need an extended time to get a roaming service. Consequently, it is difficult to guarantee the quality of VoIP service.

### SUMMARY OF THE INVENTION

It is, therefore, an object of the present invention to provide an apparatus and method for processing packets in a Wireless Local Area Network (WLAN) access point, in which the WLAN access point parses received packets, determines whether the received packets are preferentially processed in order to guarantee a quality of Voice over Internet Protocol (VoIP) service, and preferentially processes the packets determined to be preferentially processed by differentiating from other packets, thereby guaranteeing the quality of VoIP service.

It is another object of the present invention to provide an apparatus and method for processing packets in a Wireless Local Area Network access point accommodating a guarantee of a quality of voice as well as mobility.

It is yet another object of the present invention to provide an apparatus and method for processing packets in a Wireless Local Area Network access point that is efficient, simple and inexpensive to implement.

To achieve the above and other objects, there is provided an apparatus for processing packets in a Wireless Local Area Network (WLAN) access point which performs a Voice over Internet Protocol (VoIP) service through a network, the apparatus including: a storing means for storing the packets received through the network according to a priority given to the packets; a packet determining means for determining types of the packets received through the network to give the priority corresponding to the types of the determined packets; and a packet processing means for storing in the storing means the packets received through the network according to the priority given at the packet determining means and sequentially transmitting the packed stored in the storing means through the network according to the priority.

Further, the packet determining means according to the present invention includes a packet determining section for parsing headers of the packets received through the network to determine the types of the received packets, and a priority giving section for giving the priority according to the packets determined by the packet determining section.

Furthermore, the storing means according to the present invention includes a high priority queue for temporarily storing packets to which a high priority is given at the packet determining means, and a low priority queue for temporarily storing packets to which a low priority is given at the packet determining means.

In this case, the packets which the packets determining means determines to have the high priority includes at least one of voice packets, Transmission Control Protocol (TCP) signaling packets, Voice over Internet Protocol (VoIP) signaling packets, Real Time Protocol (RTP) signaling packets, mobile Internet Protocol (IP) signaling packets, and data packets of Inter Access Point Protocol (IAPP).

Another aspect of the present invention provides an apparatus for processing packets in a Wireless Local Area Network (WLAN) access point which performs a Voice over Internet Protocol (VoIP) service in cooperation with at least one of WLAN and Ethernet, the apparatus including: first and second queues for storing high priority packets and low priority packets according to a priority given to the packets received from at least one of the WLAN and the Ethernet; a packet determining unit for determining types of the packets received from at least one of the WLAN and the Ethernet to give the high priority and the low priority according to the types of the determined packets; and a packet processing unit for storing the high priority packets in the first queue when the high priority is given to the packets received from the packet determining unit, storing the low priority packets in the second queue when the low priority is given to the packets received from the packet determining unit, sequentially transmitting all of the high priority packets stored in the first queue of the first and second queues according to the priority to at least one of the WLAN and the Ethernet through a wired/wireless interface, and then sequentially transmitting all of the low priority packets stored in the second queue to at least one of the WLAN and the Ethernet through the wired/wireless interface.

Yet another aspect of the present invention provides a method for processing packets in a Wireless Local Area Network (WLAN) access point, the method including the steps of: when the packets are received from a network, parsing headers of the received packets to determine types of the packets; giving any one of high priority and low priority according to the types of the determined packets to sequentially store a plurality of packets given any one of the high priority and the low priority; transmitting the packets given the high priority among the stored plurality of packets through the network in sequence; and after the stored packets given the high priority are all transmitted, transmitting the stored packets given the low priority through the network in sequence.

Yet another aspect of the present invention provides a method for processing packets in a Wireless Local Area Network (WLAN) access point, the method including the steps of: when the packets are received from any one of WLAN and Ethernet, parsing headers of the received packets to determine types of the packets; when the determined packets are any one of the voice packets and the signaling packets, giving a high priority to the any one of the voice packets and the signaling packets, and when the determined packets are data packets, giving a low priority to the data packets; storing the plurality of packets given the high/low priority in regions different from each other according to the priority corresponding to the packets; transmitting the packets given the high priority through any one of the WLAN and the Ethernet in sequence; and after the packets given the high priority are all transmitted, transmitting the packets given the low priority through any one of the WLAN and the Ethernet in sequence.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a block diagram for illustrating a construction of a general VoIP service network;

FIG. 2 is a flow chart for describing procedures of providing a general roaming service;

FIG. 3 is a block diagram for explaining an internal construction of a WLAN access point according to a preferred embodiment of the present invention;

FIGS. 4A and 4B are operational flow charts showing a method for giving a priority to packets received at a WLAN access point according to a preferred embodiment of the present invention;

FIGS. 5A, 5B and 5C are operational flow charts showing a method for processing packets received at a WLAN access point according to a preferred embodiment of the present invention; and

FIG. 6 shows an example of a computer including a computer-readable medium having computer-executable instructions for performing a technique of the present invention.

### DETAILED DESCRIPTION OF THE INVENTION

A preferred embodiment of the present invention will be described herein below with reference to the accompanying drawings. In the following description, well-known functions or constructions are not described in detail since they would obscure the invention in unnecessary detail.

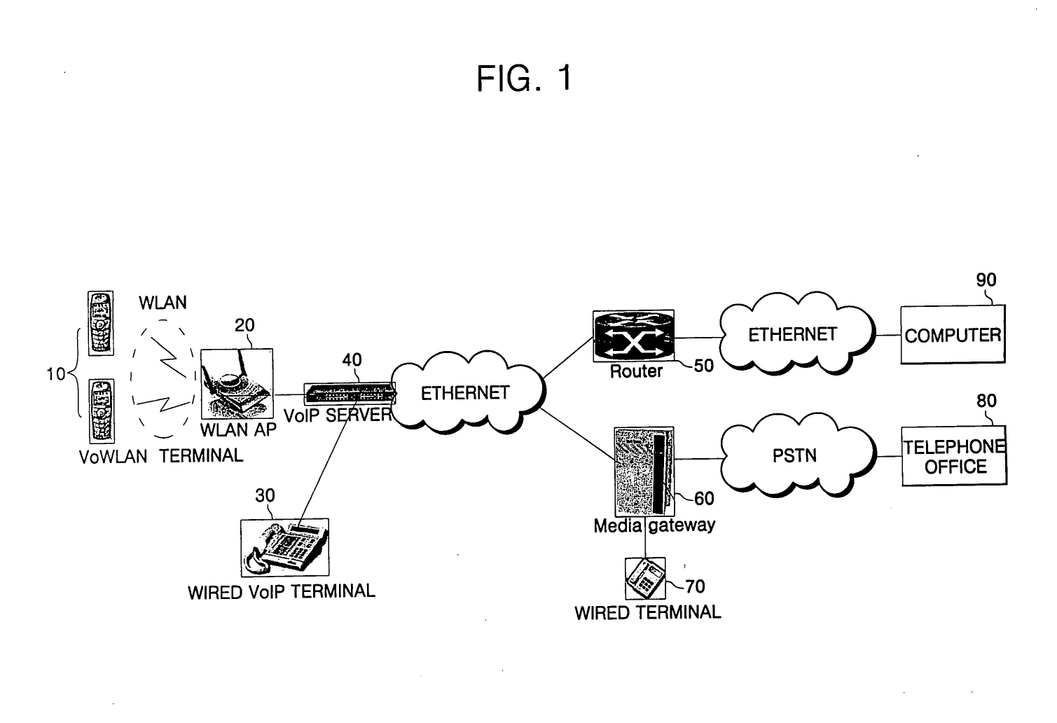

FIG. 1 is a block diagram for illustrating a construction of a general VoIP service network.

Referring to FIG. 1, the VoIP service network includes at least one VoWLAN (Voice over Wireless Local Area Network) terminal 10, a WLAN access point 20, a VoIP server 40, a wired VoIP terminal 30, a media gateway 60, a wired terminal 70, a router 50, a computer 90 and a telephone office 80.

The VoWLAN terminal 10 has access to the WLAN access point 20 through WLAN and transceives either a VoIP packet or a data packet.

Here, the VoIP packet includes a signaling packet for controlling a call in order to make a VoIP service, a voice packet for getting the VoIP service, and a signaling packet for getting a roaming service.

The VoIP server 40 provides the VoIP service when a request is made for the VoIP service from the VoWLAN terminal 10.

To be more specific, when a VoIP service request signal is received from the VoWLAN terminal 10, the VoIP server 40 sets up a call between the VoWLAN terminal 10 and the wired VoIP terminal 30 or transmits the VoIP service request signal to the media gateway 60 or the router 50 through Ethernet. Thereby, the VoIP server 40 provides the VoIP service.

Further, when the VoIP service request signal is received either from the computer 90 through the router 50 or from the telephone office 80 through the media gateway 60, the VoIP server 40 is designed to set up a call either to the wired VoIP terminal 30 or to the VoWLAN terminal 10 through the WLAN access point 20 based on the received VoIP service request signal.

The wired VoIP terminal 30 receives the VoIP service request signal from any other VoIP terminal through the VoIP server 40, otherwise transmits the VoIP service request signal to any other VoIP terminal, thereby setting up the call to the corresponding VoIP terminal.

The media gateway 60 is connected with the VoIP server 40 through the Ethernet and allows the call to be set up between the VoIP server 40 and the telephone office 80 through a Public Switched Telephone Network (PSTN).

The wired terminal 70 receives the VoIP service request signal from any other VoIP terminal through the media gateway 60, otherwise transmits the VoIP service request signal to any other VoIP terminal, thereby setting up the call to the corresponding VoIP terminal.

The router 50 performs routing of the packet received from the VoIP server 40 to transmit the received packet to a destination.

The WLAN access point 20 temporarily stores in a queue the packet received from the VoWLAN terminal 10 through the WLAN, and transmits the stored packet to a desired destination through the Ethernet.

Alternatively, the WLAN access point 20 may force the packet received through the Ethernet to be temporarily stored in the queue, and may transmit the stored packet to the VoWLAN terminal 10, as a desired destination, through the WLAN.

Further, the WLAN access point 20 provides a roaming service in order to guarantee mobility of the VoWLAN terminal 10.

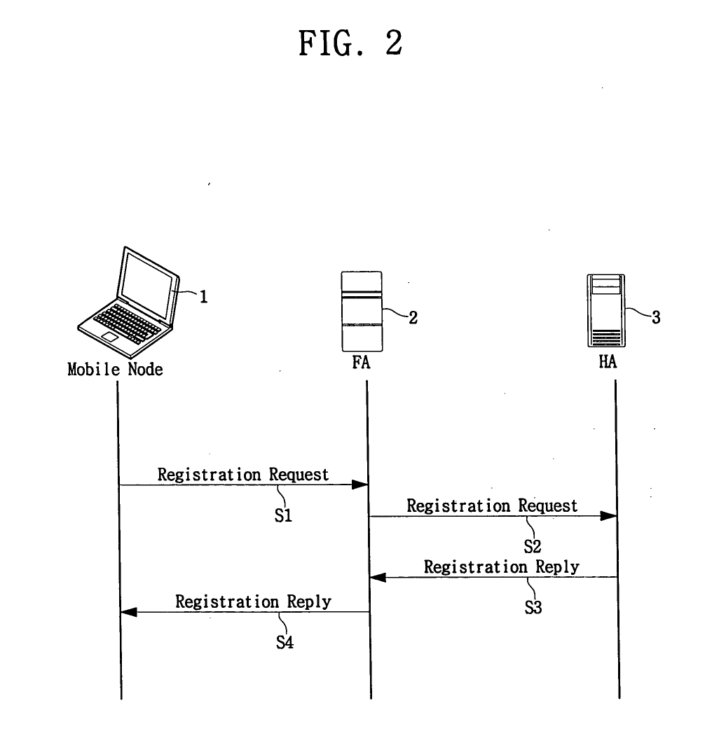

FIG. 2 is a flow chart for describing procedures of providing a general roaming service.

As shown in FIG. 2, a mobile node 1 may be implemented as a host, a router or so forth, which changes an attachment point from one location to another location within one network or sub-network. Herein, the VoWLAN terminal 10 corresponds to the mobile node 1.

Further, a foreign agent 2 is the router to which the mobile node 1 has access. Herein, the WLAN access point 20 corresponds to the foreign agent 2.

In this case, the mobile node 1 and the foreign agent 2 are connected with each other through the WLAN defined by IEEE 802.11b (alternatively for example, IEEE 802.11a, IEEE 802.11g, or other IEEE 802.11, or other WLAN technology that provides a Voice over Internet Protocol (VoIP) service, or the combination of at least two different protocols can also be used).

A home agent 3 is the home network router of the mobile node 1, and maintains information on the present location of the mobile node 1 when the mobile node 1 moves to another location.

Description will be made on procedures by which the WLAN access point 20 provides a roaming service with reference to FIG. 2.

As shown in FIG. 2, when the mobile node 1 moves from a present location to another location, the moved mobile node 1 transmits a registration request message to the foreign agent 2 (S1).

When the foreign agent 2 receives the registration request message from the moved mobile node 1, the foreign agent 2 transmits the registration request message of the moved mobile node 1 to the correspondent home agent 3 through the Ethernet (S2).

When the home agent 3 receives the registration request message of the moved mobile node 1 from the foreign agent 2, the home agent 3 requests the foreign agent 2 to update an Address Resolution Protocol (ARP) table of the moved mobile node 1 related to all other linked nodes, and transmits a registration response message in response to the registration request message to the foreign agent 2 (S3). Here, ARP is a protocol used to get an IP address to correspond to a physical network address on the IP network.

When the foreign agent 2 receives the registration response message from the home agent 3, the foreign agent 2 transmits the received registration response message to the moved mobile node 1 (S4).

In this manner, according to the method for providing the roaming service to the VoWLAN terminal 10 on the WLAN, while stably maintaining a network connection state using softwares and hardwares, the VoWLAN terminal 10 monitors a signal intensity of the WLAN access point 20 within a service area to have access to the WLAN access point 20 having the highest signal intensity, so that it is possible to perform roaming from one WLAN access point 20 to another WLAN access point 20.

When the mobile IP related signaling packet for performing this roaming service is processed equally to the data packet, the roaming service is delayed and so causes deterioration of QoS. For this reason, the WLAN access point 20 has to give a higher priority to the mobile IP related signaling packet for preferential processing.

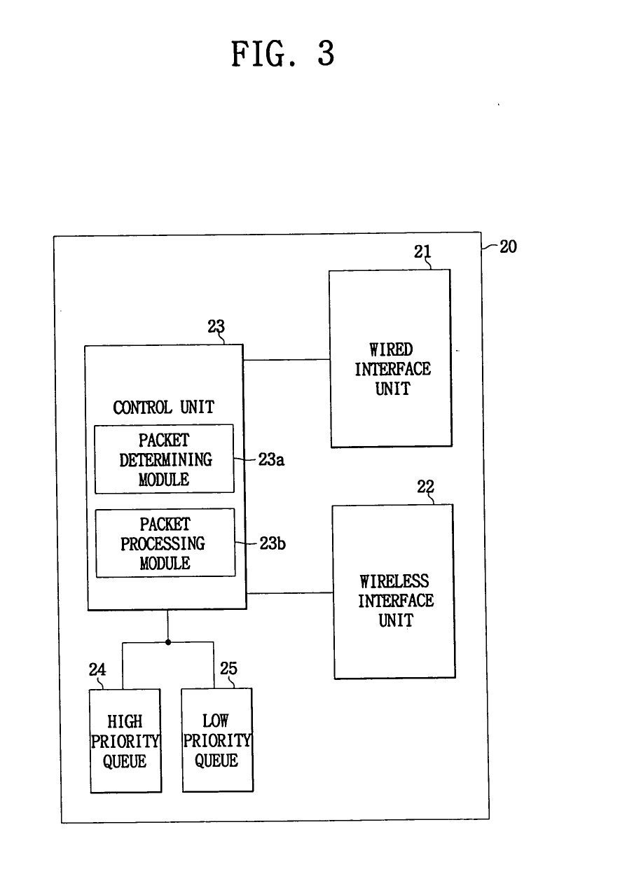

FIG. 3 is a block diagram for explaining an internal construction of a WLAN access point according to a preferred embodiment of the present invention.

As shown in FIG. 3, the WLAN access point 20 employed to the present invention includes a wired interface unit 21, a wireless interface unit 22, a control unit 23, a high priority queue 24 and a low priority queue 25.

The control unit 23 includes a packet determining module 23a and a packet processing module 23b.

The wired interface unit 21 performs interfacing so as for the WLAN access point 20 to transmit/receive (transmit or receive or both transmit and receive) packets to/from (to or from or both to and from) the VoWLAN terminal 10 or the VoIP server 40 through the Ethernet.

The wireless interface unit 22 performs interfacing so as for the WLAN access point 20 to transmit/receive packets to/from the VoWLAN terminal 10 through the WLAN.

The control unit 23 performs functions of parsing packets, which are received either from the Ethernet through the wired interface unit 21 or from the WLAN through the wireless interface unit 22, giving a high or low priority based on the parsed result, temporarily storing received packets in the corresponding queue 24 or 25, and processing the temporarily stored packets.

The packet determining module 23a of the control unit 23 parses each header of packets, which are received either from the Ethernet through the wired interface unit 21 or from the WLAN through the wireless interface unit 22, determines which one of the received packets must be preferentially processed in order to guarantee the quality of VoIP service, and gives a priority to the corresponding packet according to the determined result.

To be more specific, the packet determining module 23a determines whether the received packet is a signaling packet needed to assist mobility of the VoWLAN terminal 10, or a signaling packet of a call control protocol for providing the VoIP service.

Here, the signaling packet of the call control protocol may be exemplified by packets associated with H.323, H.245, Session Initiation Protocol (SIP) and RTP Control Protocol (RTCP), which are protocols for providing the VoIP service, and the signaling packet for assisting the mobility of the VoWLAN terminal 10 may be exemplified by a signaling packet of mobile IP, a data packet of Inter-Access Point Protocol (IAPP), and so forth.

As such, the packet determining module 23a gives a high priority to the packet needed to be preferentially processed in order to guarantee the quality of VoIP service, for example a voice packet, a VoIP call control protocol packet, a mobile IP related packet, an IAPP data packet, or so forth, but gives a low priority to data packets other than the high priority packets.

Here, the packet determining module 23a can parse a header of the corresponding packet to determine what type of packet the parsed packet is.

Various information on fields of a general IP packet header, such as field name, the number of bits and field description, are listed on Table 1 as follows.

TABLE 1

| | Number | |
|---|---|---|
| | of | |
| Field Name | Bits | Field Description |
| Version | 4 | indicate the current version of IP |
| Header length | 4 | indicate IP header length in unit of 32-bit |
| | | words |
| Type of Service | 8 | provide a priority of IP packets |
| Flags | | |
| Total Packet | 16 | indicate the length of the total IP packets |
| Length | | including IP packet header and body in unit |
| | | of bytes |
| Fragmentation | 16 | indicate a serial number of original IP |
| Identifier | | datagrams to which fragments belong |
| Fragmentation | 3 | indicate characteristics of all generated |
| Flags | | fragmentations and provide a fragmentation |
| | | control service in which routers prevent |
| | | fragmentation of a packet |
| Fragmentation | 13 | indicate the byte range start point of the |
| Offset | | original datagrams stored in the present |
| | | fragment by 8-byte offset |
| Time to Live | 8 | indicate the number of movable steps before |
| | | the datagrams become extinct due to deter- |
| | | mination that the datagrams can not be |
| | | transmitted |
| Protocol Identifier | 8 | indicate an upper layer protocol stored in the |
| | | body of the IP datagrams |
| Header Check | 16 | indicate a check sum of the IP header which |
| sum | | can identify a damage of data |
| Source IP | 32 | indicate 32-bit IP address of the original host |
| Address | | transmitting datagrams |
| Destination IP | 32 | indicate 32-bit IP address of the final desti- |
| Address | | nation to receive datagrams |

As set forth in Table 1, the packet determining module 23a can parse a protocol identifier field area of the received packet header, thereby determining a type of the received packet.

For example, the packet determining module 23a parses the protocol identifier field area of the received packet header. If a value of the field area is “6,” the received packet is determined to be a TCP packet. If a value of the field area is “17,” the received packet is determined to be a User Datagram Protocol (UDP) packet.

Meanwhile, on the basis of a priority of the packet given by the packet determining module 23a, the packet processing module 23b temporarily stores the packets in the corresponding queue 24 or 25, and processes the temporarily stored packet according to its priority.

To be more specific, the packet processing module 23b temporarily stores a packet to which the packet determining module 23a gives a high priority in the high priority queue 24, but the packet processing module 23b temporarily stores a packet to which the packet determining module 23a gives a low priority in the low priority queue 25.

Further, when packets received for a predetermined time are stored in the corresponding queue 24 or 25 according to the priority given by the packet determining module 23a, the packet processing module 23b preferentially processes the packets which are temporarily stored in the high priority queue 24. Then, when the high priority queue 24 becomes a free state, the packet processing module 23b processes the packets which are temporarily stored in the low priority queue 25.

That is to say, it is determined whether packets are stored in the high priority queue 24. If so, the packets, which are given the high priority and are stored in the high priority queue 24, are preferentially outputted either to the WLAN through the wireless interface unit 22 or to the Ethernet through the wired interface unit 21.

Then, the packet processing module 23b determines whether all packets stored in the high priority queue 24 are processed to become a free state. If so, the packets stored in the low priority queue 25 are outputted either to the WLAN through the wireless interface unit 22, or to the Ethernet through wired interface unit 21.

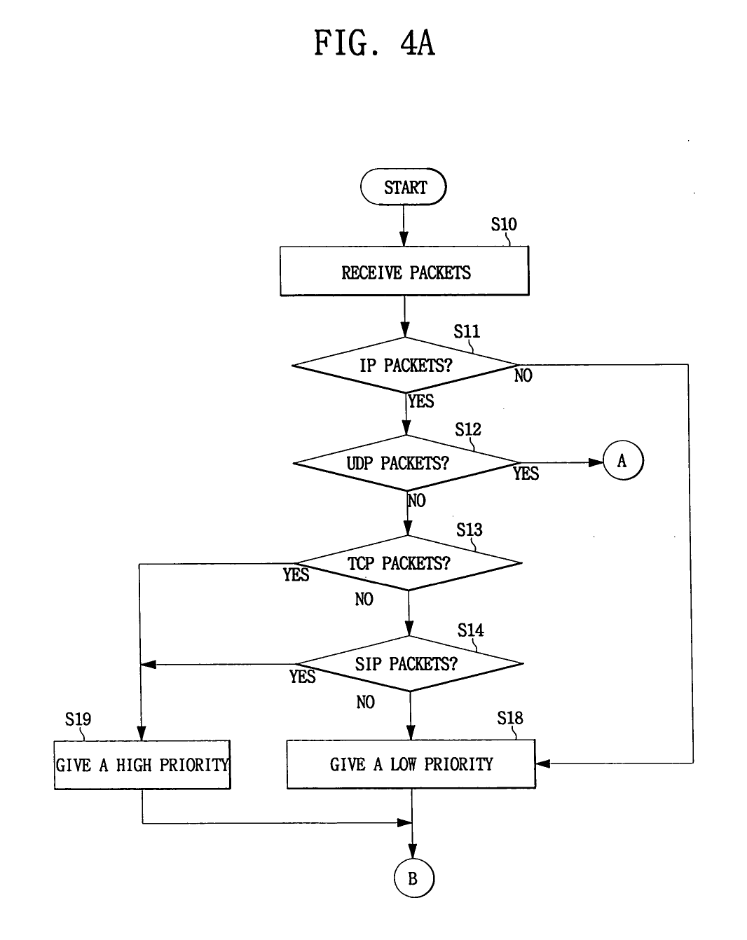

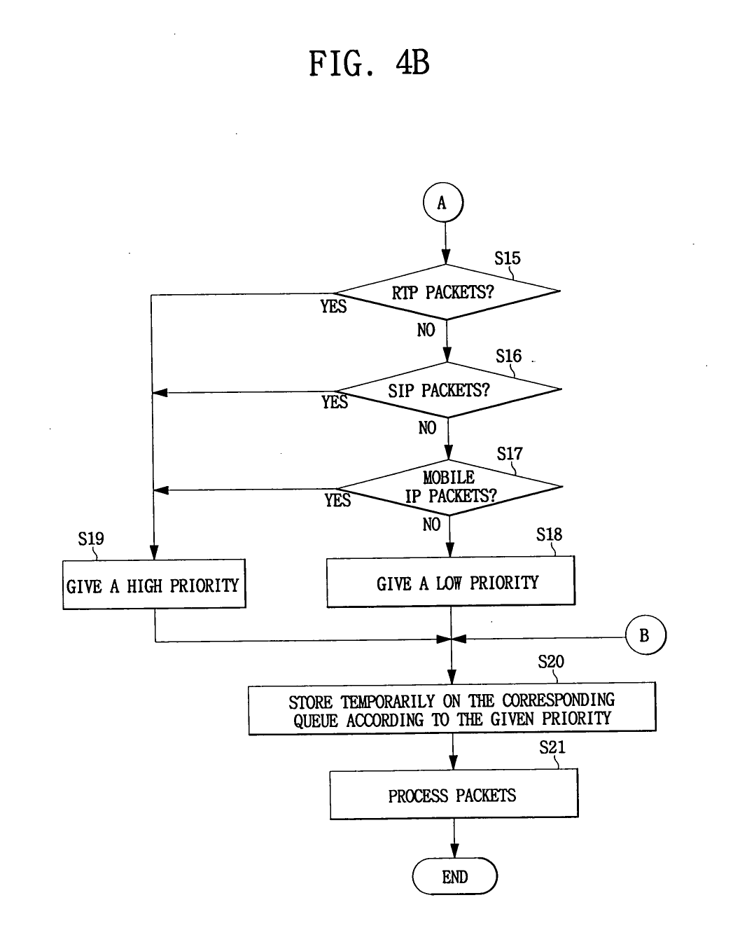

FIGS. 4A and 4B are operational flow charts showing a method for giving a priority to packets received at a WLAN access point according to a preferred embodiment of the present invention.

Referring to FIGS. 4A and 4B, the control unit 23 of the WLAN access point 20 receives packets either from the WLAN through the wireless interface unit 22 or from the Ethernet through the wired interface unit 21 (S 10).

Then, the packet determining module 23a of the control unit 23 determines whether the received packets are voice packets. If the received packets are voice packets, the packet determining module 23a gives a high priority to the corresponding packets.

However, if the received packets are not voice packets, then the packet determining module 23a determines whether the received packets are IP packets (S11). As the determined result, if the received packets are not IP packets, the packet determining module 23a determines the received packets not to be ones which must be preferentially processed in order to guarantee QoS, and then gives a low priority to the received packets (S18).

However, if the received packets are IP packets, it is determined whether the received packets are UDP (User Datagram Protocol) packets (S12). As the determined result, if not UDP packets, it is determined whether the received packets are Transmission Control Protocol (TCP) packets (S13). If the received packets are the TCP packets, the received packets are determined to be ones which must be preferentially processed in order to ensure the quality of VoIP service, and given the high priority (S19).

As the determined result, if not TCP packets, it is determined whether the received packets are SIP packets (S14). Then, if the received packets are neither the TCP packets nor the SIP packets, the control unit 23 gives the low priority to the received packets (S18). If the received packets are not the TCP packets but are SIP packets, the received packets are determined to be ones which must be preferentially processed in order to ensure the quality of VoIP service, and given the high priority (S19).

Here, determining whether or not the received packets are the SIP packets is based on determination of whether or not the received packets are packets for performing a call control according to SIP. Thus, if using SIP of VoIP, it is determined whether or not the received packets are signaling packets related to the call control. If the call is controlled using H.323 or Media Gateway Control Protocol (MGCP), or so forth, it is determined whether or not the received packets are the signaling packets for controlling the call according to the corresponding protocol.

By contrast, if the received packets are the TCP packets, the packet determining module 23a gives the high priority to the corresponding packets (S19).

Meanwhile, as the result of determining whether the received packets are the UDP packets (S12), if the received packets are the UDP packets, it is determined whether the received packets are RTP packets (S15).

Here, RTP is a kind of Internet protocol for exchanging packets in a real time.

As the determined result, if the received packets are the RTP packets, the high priority is given to the received packets (S19). However, if the received packets are not RTP packets, it is determined whether the received packets are the SIP packets (S16).

If the received packets are not the RTP packets but the SIP packets, the high priority is given to the received packets (S19). Further, if the received packets are neither the RTP packets nor the SIP packets, it is determined whether the received packets are mobile IP (Internet Protocol) packets (S117).

As the determined result, if the received packets are mobile IP packets, the high priority is given to the received packets (S19). However, if the received packets are not mobile IP packets, the low priority is given to the received packets (S18).

The packet processing module 23b temporarily stores packets, to which the packet determining module 23a gives the high priority, in the high priority queue 24, but it temporarily stores packets, to which the packet determining module 23a gives the low priority, in the low priority 11 queue 25 (S20).

The packet processing module 23b parses packets which the packet determining module 23a receives. Thus, when packets having a priority are temporarily stored in the corresponding queue 24 or 25 for a predetermined time, packets stored temporarily in the high priority queue 24 are preferentially processed. Then, when the packets stored in the high priority queue 24 are completely processed, packets stored in the low priority queue 25 are processed (S21).

In other words, the packet processing module 23b preferentially outputs packets, which are given the high priority and are stored temporarily in the high priority queue 24, such as voice packets, TCP packets, SIP packets, RTP packets and mobile IP packets, either to the Ethernet through the wired interface unit 21, or to the WLAN through the wireless interface unit 22.

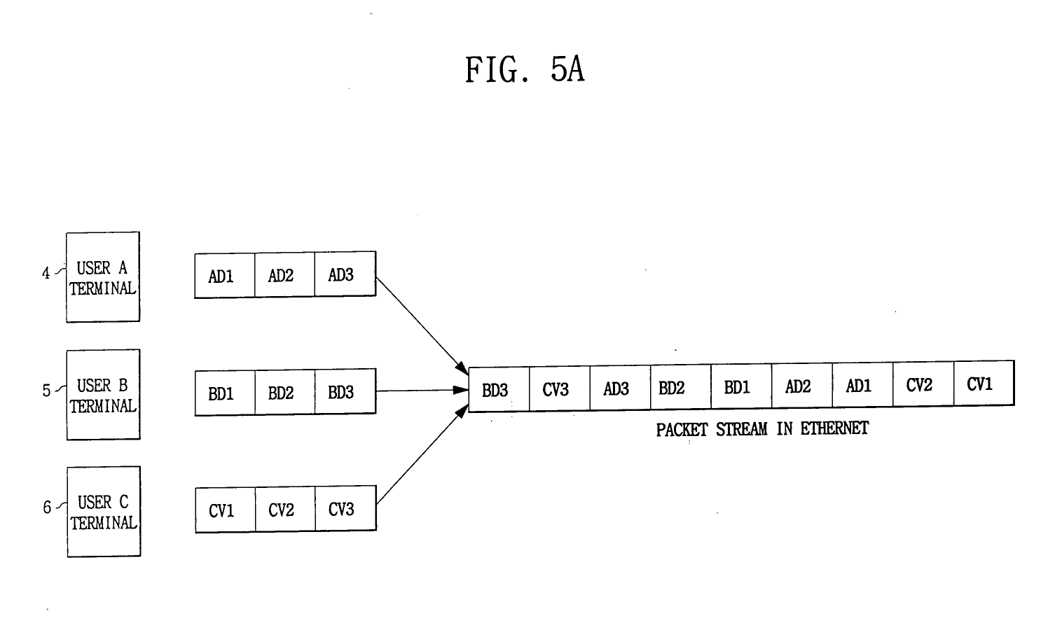

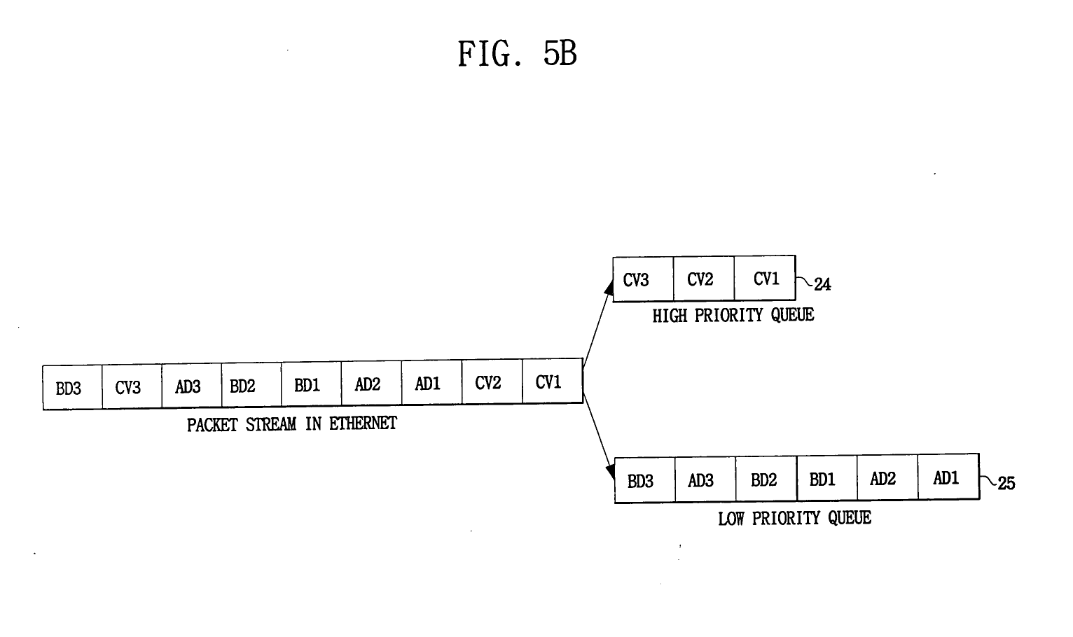

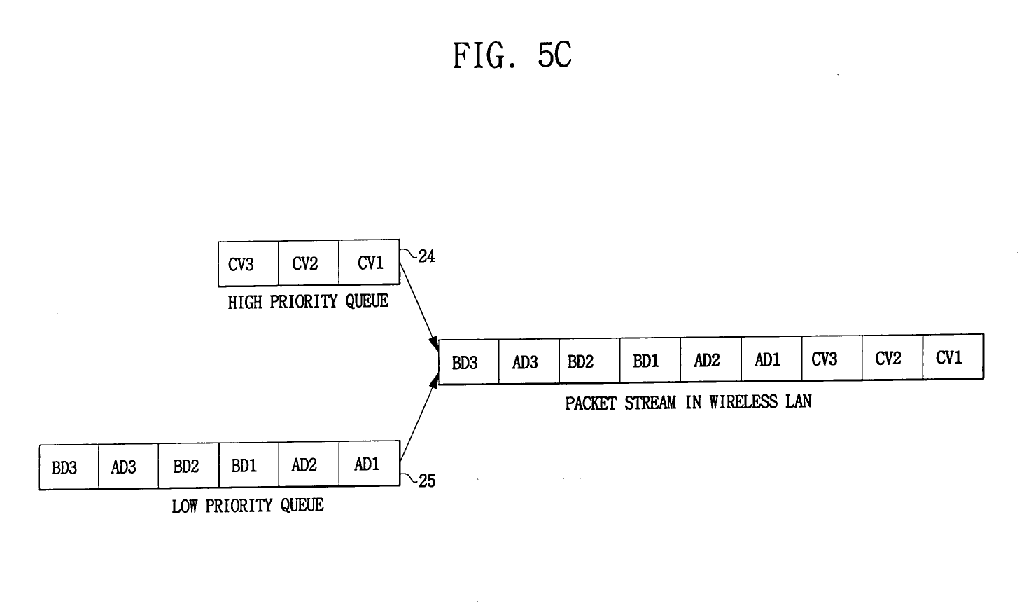

FIGS. 5A, 5B and 5C are operational flow charts showing a method for processing packets received at a WLAN access point according to a preferred embodiment of the present invention.

FIG. 5A shows flow for receiving packets from a plurality of users through Ethernet. It will be described that terminals 4 and 5 of users A and B transmit data packets, and that a terminal 6 of a user C transmits voice packets.

The user A terminal 4 transmits data packets AD1, AD2 and AD3, and the user B terminal 5 transmits data packets BD1, BD2 and BD3.

The user C terminal 6 transmits voice packets CV1, CV2 and CV3.

These multiple user terminals transmit their own packets to the Ethernet according to a technique of Carrier Sense Multiple Access with Collision Detection (CSMA/CD). In this case, these packets are sequentially transmitted without any priority between the data and voice packets.

CSMA/CD is a transport protocol of the Ethernet and is standardized by IEEE 802.3. By examining CSMA/CD for some time, apparatuses which have given access to the Ethernet can transmit packets at any time. To this end, before the packets are transmitted, it is monitored whether a traffic channel is in a busy state. When the traffic channel becomes an idle state, the packets are transmitted.

In the case that one apparatus transmits packets and, at the same time another apparatus initiates to transmit packets, a collision between packets occurs, the packets undergoing this collision are on standby for some time and then retransmitted.

Thus, the packets transmitted from each of the user terminals 4, 5 and 6 are transmitted to the Ethernet in the sequence of CV1, CV2, AD1, AD2, BD1, BD2, AD3, CV3 and BD3.

That is, the data packets and the voice packets are transmitted to the Ethernet without any priority.

As shown in FIG. 5B, the WLAN access point 20 receives data and voice packets on the Ethernet without any differentiation between the data and voice packets.

The packet determining module 23a parses headers of the packets received from the wired interface unit 21, and then determines whether the received packets are the voice packets or the data packets. As the determined result, if the received packets are the voice packets, the high priority is given to the received packets. However, if the received packets are the data packets, the low priority is given to the received packets.

The packet processing module 23b temporarily stores the received packets in the corresponding queue 24 or 25 according to the priority given to the received packets.

That is to say, the packet determining module 23a of the WLAN access point 20 parses the packets received in sequence, i.e., CV1, CV2, AD1, AD2, BD1, BD2, AD3, CV3 and BD3, and checks whether the received packets are the voice packets or the data packets.

Then, if it is checked (determined) that the received packets are the voice packets CV1, CV2 and CV3, a high priority is given to the received packets. However, if the received packets are the data packets AD1, AD2, BD1, BD2, AD3 and BD3, a low priority is given to the received packets.

Subsequently, the packet processing module 23b temporarily stores the voice packets CV1, CV2 and CV3 given the high priority in the high priority queue 24, while it temporarily stores the data packets AD1, AD2, BD1, BD2, AD3 and BD3 given the low priority in the low priority queue 25.

As shown in FIG. 5C, the packet processing module 23b preferentially transmits the voice packets CV1, CV2 and CV3, which are given the high priority and are temporarily stored in the high priority queue 24, to the VoWLAN terminal 10 through the wireless interface unit 22.

Then, the voice packets CV1, CV2 and CV3 stored temporarily in the high priority queue 24 are completely processed, and so when the high priority queue 24 becomes a free state, the packet processing module 23b transmits the data packets AD1, AD2, BD1, BD2, AD3 and BD3, which are given the low priority and are temporarily stored in the low priority queue 25, to the VoWLAN terminal 10 through the wireless interface unit 22.

Meanwhile, when the packets are received through the wireless interface unit 22, the packet determining module 23a parses the received packets, and determines whether the received packets are the voice packets or the data packets. As the determined result, if the received packets are the voice packets, the high priority is given to the received packets. However, if the received packets are the data packets, the low priority is given to the received packets.

Then, the packet processing module 23b temporarily stores the voice packets, to which the packet determining module 23a gives the high priority, in the high priority queue 24. By contrast, the packet processing module 23b temporarily stores the data packets, to which the packet determining module 23a gives the low priority, in the low priority queue 25.

Further, when a predetermined time lapses, the packet processing module 23b outputs the voice packets stored temporarily in the high priority queue 24 to the Ethernet through the wired interface unit 21. Moreover, then, the voice packets stored temporarily in the high priority queue 24 are completely processed, and then when the high priority queue 24 becomes a free state, the packet processing module 23b outputs the data packets stored temporarily in the low priority queue 25, to the Ethernet through the wired interface unit 21.

As such, description has been made about the case that the user C terminal 6 transmits the voice packets. However, this is equally true of the case that packets, to which the high priority is given by the packet determining module 23a of other WLAN access points 20, such as TCP packets, SIP packets, RTP packets, mobile IP packets and IAPP data packets, are received.

The present invention can be realized as computer-executable instructions in computer-readable media. The computer-readable media includes all possible kinds of media in which computer-readable data is stored or included or can include any type of data that can be read by a computer or a processing unit. The computer-readable media include for example and not limited to storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that may be local or remote to the processing system. The present invention can include the computer-readable medium having stored thereon a data structure including a plurality of fields containing data representing the techniques of the present invention.

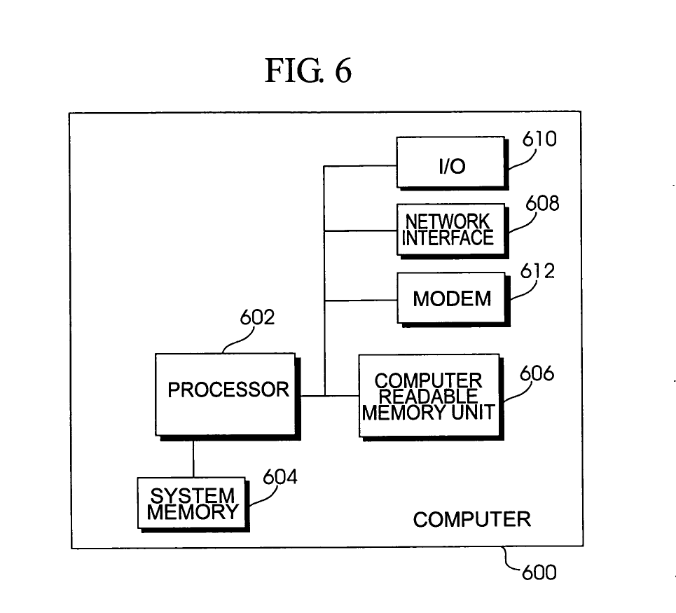

An example of a computer, but not limited to this example of the computer, that can read computer readable media that includes computer-executable instructions of the present invention is shown in FIG. 6. The computer 600 includes a processor 602 that controls the computer 600. The processor 602 uses the system memory 604 and a computer readable memory device 606 that includes certain computer readable recording media. A system bus connects the processor 602 to a network interface 608, modem 612 or other interface that accommodates a connection to another computer or network such as the Internet. The system bus may also include an input and output interface 610 that accommodates connection to a variety of other devices.

Although a preferred embodiment of the present invention has been described for illustrative purposes, it is apparent to those skilled in the art that various modifications, additions and substitutions are possible, without departing from the scope and spirit of the invention as disclosed in the accompanying claims.

As can be seen from the foregoing, according to the present invention, packets received from a WLAN access point are parsed. It is determined whether or not the received packets are packets, which must be preferentially processed in order to guarantee a quality of VoIP service, i.e., voice packets, call control signaling packets, or mobile IP packets. If the received packets are packets to be preferentially processed, these packets are temporarily stored in a state differentiated from data packets. Thus, it is possible to guarantee a quality of voice as well as mobility, and to provide a better quality of VoIP service to a user.

1. An apparatus for processing packets in a Wireless Local Area Network access point which performs a Voice over Internet Protocol service through a network, the apparatus comprising:
a storing unit storing the packets received through the network according to a priority given to the packets;
a packet determining unit determining types of the packets received through the network to give the priority corresponding to the types of the determined packets; and
a packet processing unit storing in said storing unit the packets received through the network according to the priority given at said packet determining unit and sequentially transmitting the packets stored in said storing unit through the network according to the priority.

2. The apparatus according to claim 1, wherein the packet determining unit comprises:
a packet determining section parsing headers of the packets received through the network to determine the types of the received packets; and
a priority giving section giving the priority according to the types of the packets determined by said packet determining section.

3. The apparatus according to claim 1, wherein said storing unit comprises:
a high priority queue temporarily storing packets to which a high priority is given by the packet determining unit; and
a low priority queue temporarily storing packets to which a low priority is given by the packet determining unit.

4. The apparatus according to claim 3, wherein the packets having the high priority comprise at least one of voice packets, Transmission Control Protocol signaling packets, Voice over Internet Protocol signaling packets, Real Time Protocol signaling packets, mobile Internet Protocol signaling packets, and data packets of Inter Access Point Protocol.

5. The apparatus according to claim 4, wherein the Voice over Internet Protocol signaling packets comprise at least one of Session Initiation Protocol signaling packets, H.323 signaling packets, H.245 signaling packets, and Media Gateway Control Protocol signaling packets.

6. The apparatus according to claim 3, wherein the packets having the high priority comprise signaling packets related to a call control for controlling the call according to the corresponding protocol when using Session Initiation Protocol of Voice over Internet Protocol.

7. The apparatus according to claim 3, wherein the packets having the high priority comprise of voice packets and signaling packets related to a call control for controlling the call according to the corresponding protocol when using with the signaling packets related to call control being selected from a group consisting of H.323 signaling packets, H.245 signaling packets, and Media Gateway Control Protocol signaling packets.

8. The apparatus according to claim 1, with a highest priority being given to voice packets and packets accommodating roaming service for Voice over Internet Protocol terminals between a plurality of Wireless Local Area Network access points.

9. The apparatus according to claim 1, with said packet determining unit prioritizing the received packets according to the quality of the Voice over Internet Protocol service.

10. The apparatus according to claim 1, with said packet determining unit determining the highest priority for received packets being signaling packets of a call control protocol providing the Voice over Internet Protocol service or signaling packets needed to assist the mobility of Voice over Internet Protocol terminals.

11. The apparatus according to claim 10, with said packet determining unit determining a lower priority for received packets being data packets other than any data packets being higher priority packets.

12. The apparatus according to claim 3, with only when the high priority queue becomes a free state, only then the packet processing unit processes the packets temporarily stored in the low priority queue for transmission.

13. The apparatus according to claim 3, with the packets given the high priority being preferentially outputted to either the Wireless Local Area Network through a wireless interface unit or to an Ethernet through a wired interface unit.

14. An apparatus for processing packets in a Wireless Local Area Network access point which performs a Voice over Internet Protocol service in cooperation with at least one of Wireless Local Area Network and Ethernet, the apparatus comprising:
first and second queues storing high priority packets and low priority packets received from at least one of the Wireless Local Area Network and the Ethernet according to a priority given to both of the packets;
a packet determining unit determining types of the packets received from at least one of the Wireless Local Area Network and the Ethernet to give the high priority and the low priority according to the types of the determined packets; and
a packet processing unit storing the high priority packets in the first queue when the high priority is given to the packets received from said packet determining unit, storing the low priority packets in the second queue when the low priority is given to the packets received from said packet determining unit, sequentially transmitting all of the high priority packets stored in the first queue of the first and second queues according to the priority to at least one of the Wireless Local Area Network and the Ethernet through a wired and wireless interface, and then sequentially transmitting all of the low priority packets stored in the second queue to at least one of the Wireless Local Area Network and the Ethernet through the wired and wireless interface.

15. The apparatus according to claim 14, wherein said packet determining unit gives the high priority when the received packets include any one of voice packets, Transmission Control Protocol signaling packets, Voice over Internet Protocol signaling packets, Real Time Protocol signaling packets, mobile Internet Protocol signaling packets, and data packets of Inter Access Point Protocol, and said packet determining unit gives the low priority when the received packets include the data packets.

16. The apparatus according to claim 15, wherein the Voice over Internet Protocol signaling packets comprise at least one of Session Initiation Protocol signaling packets, H.323 signaling packets, H.245 signaling packets, and Media Gateway Control Protocol signaling packets.

17. The apparatus according to claim 14, with sequentially in seriatim transmitting all of the high priority packets stored in the first queue according to the priority, and then sequentially in seriatim transmitting all of the low priority packets stored in the second queue.

18. A method for processing packets in a Wireless Local Area Network access point, the method comprising the steps of:
when the packets are received from a network, parsing headers of the received packets to determine types of the packets;
giving any one of high priority and low priority according to the types of the determined packets to sequentially store a plurality of the packets given any one of the high priority and the low priority;
transmitting the packets given the high priority among the stored plurality of packets through the network in sequence; and
after the stored packets given the high priority are all transmitted, transmitting the stored packets given the low priority through the network in sequence.

19. The method according to claim 18, wherein the packets given the high priority comprise at least one of voice packets, Transmission Control Protocol signaling packets, Voice over Internet Protocol signaling packets, Real Time Protocol signaling packets, mobile Internet Protocol signaling packets, and data packets of Inter Access Point Protocol.

20. The method according to claim 19, wherein the Voice over Internet Protocol signaling packets comprise at least one of Session Initiation Protocol signaling packets, H.323 signaling packets, H.245 signaling packets, and Media Gateway Control Protocol signaling packets.

21. A method for processing packets in a Wireless Local Area Network access point, the method comprising the steps of:
when the packets are received from any one of Wireless Local Area Network and Ethernet, parsing headers of the received packets to determine types of the packets;
when the determined packets are any one of voice packets and signaling packets, giving a high priority to the any one of voice packets and signaling packets, and when the determined packets are data packets, giving a low priority to the data packets;
storing the plurality of packets given the high and low priority in regions different from each other according to the priority corresponding to the packets;
transmitting the packets given the high priority through any one of the Wireless Local Area Network and the Ethernet in sequence; and
after the packets given the high priority are all transmitted, transmitting the packets given the low priority through any one of the Wireless Local Area Network and the Ethernet in sequence.

22. The method according to claim 21, wherein the packets given the high priority comprise at least one of voice packets, Transmission Control Protocol signaling packets, Voice over Internet Protocol signaling packets, Real Time Protocol signaling packets, mobile Internet Protocol signaling packets, and data packets of Inter Access Point Protocol.

23. The method according to claim 22, wherein the Voice over Internet Protocol signaling packets comprise at least one of Session Initiation Protocol signaling packets, H.323 signaling packets, H.245 signaling packets, and Media Gateway Control Protocol signaling packets.

24. A method, comprising:
receiving data and voice packets;
parsing headers of the received packets to determine the kind of the packets when the packets are received;
assigning any one of high priority and low priority according to the kind of the determined packets;
transmitting the packets assigned the high priority among the stored plurality of packets through a network before transmitting the stored packets given the low priority through the network.

25. The method of claim 24, further comprising of storing the received packets according to the priority before transmitting the packets according to the priority.

26. The method of claim 25, further comprised of determining the high priority for received packets being signaling packets of a call control protocol providing a Voice over Internet Protocol service or signaling packets needed to assist the mobility of Voice over Internet Protocol terminals.

27. The method of claim 24, wherein the packets having the high priority comprise at least one of voice packets, Transmission Control Protocol signaling packets, Voice over Internet Protocol signaling packets, Real Time Protocol signaling packets, mobile Internet Protocol signaling packets, and data packets of Inter Access Point Protocol.

28. A computer-readable medium having computer-executable instructions for performing a method, comprising:
when the packets are received from a network, parsing headers of the received packets to determine types of the packets;
giving any one of high priority and low priority according to the types of the determined packets to sequentially store a plurality of the packets given any one of the high priority and the low priority;
transmitting the packets given the high priority among the stored plurality of packets through the network in sequence; and
after the stored packets given the high priority are transmitted, transmitting the stored packets given the low priority through the network in sequence.

29. The computer-readable medium having computer-executable instructions for performing the method of claim 28, wherein:
the packets given the high priority comprise at least one of voice packets, Transmission Control Protocol signaling packets, Voice over Internet Protocol signaling packets, Real Time Protocol signaling packets, mobile Internet Protocol signaling packets, and data packets of Inter Access Point Protocol; and
the Voice over Internet Protocol signaling packets comprises at least one of Session Initiation Protocol signaling packets, H.323 signaling packets, H.245 signaling packets, and Media Gateway Control Protocol signaling packets.

30. A computer-readable medium having stored thereon a data structure comprising:
a first field containing data representing when the packets are received from any one of Wireless Local Area Network and Ethernet, parsing headers of the received packets to determine types of the packets;
a second field containing data representing when the determined packets are any one of voice packets and signaling packets, giving a high priority to the any one of voice packets and signaling packets, and when the determined packets are data packets, giving a low priority to the data packets;
a third field containing data representing storing the plurality of packets given the high and low priority in regions different from each other according to the priority corresponding to the packets;
a fourth field containing data representing transmitting the packets given the high priority through any one of the Wireless Local Area Network and the Ethernet in sequence; and
a fifth field containing data representing after the packets given the high priority are all transmitted, transmitting the packets given the low priority through any one of the Wireless Local Area Network and the Ethernet in sequence.
